(19) United States
(12) Patent Application Publication
(10) Pub. No.: US 2026/0037817 A1
(43) Pub. Date: Feb. 5, 2026

(54) HYBRID SEQUENTIAL TRAINING FOR ENCODER AND DECODER MODELS

(71) Applicant: QUALCOMM Incorporated, San Diego, CA (US)

(72) Inventors: Abdelrahman Mohamed Ahmed Mohamed IBRAHIM, San Diego, CA (US); Taesang YOO, San Diego, CA (US); Jay Kumar SUNDARARAJAN, San Diego, CA (US); June NAMGOONG, San Diego, CA (US); Pavan Kumar VITTHALADEVUNI, San Diego, CA (US); Chenxi HAO, Beijing (CN)

(21) Appl. No.: 19/100,290

(22) PCT Filed: Jul. 24, 2023
(86) PCT No.: PCT/CN2023/108814

§ 371 Date: Jan. 31, 2025

(30) Foreign Application Priority Data
Nov. 4, 2022 (WO) PCT/CN2022/129967

(51) Int. Cl. G06N 3/09; G06N 3/0455; H04B 7/0417; H04W 24/02

(52) U.S. Cl. CPC G06N 3/09; G06N 3/0455; H04B 7/0417; H04W 24/02

(57) ABSTRACT

Various aspects of the present disclosure generally relate to wireless communication. In some aspects, a first device may receive, from a second device, a function associated with a trained first model, the function being configured to output one or more gradients associated with the trained first model. The first device may train a second model based on selecting one or more weights associated with the second model using the one or more gradients, the one or more gradients being obtained based on inputting one or more activations and one or more inputs into the function. Numerous other aspects are described.

### CROSS-REFERENCE TO RELATED APPLICATION

This Patent Application claims priority to PCT Patent Application No. PCT/CN2022/129967, filed on Nov. 4, 2022, entitled “HYBRID SEQUENTIAL TRAINING FOR ENCODER AND DECODER MODELS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for hybrid sequential training for encoder and decoder models.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY Some aspects described herein relate to a first device for wireless

communication. The first device may include one or more memories and one or more processors coupled to the one or more memories. The one or more processors may be configured to receive, from a second device, a function associated with a trained first model, the function being configured to output one or more gradients associated with the trained first model. The one or more processors may be configured to train a second model based on selecting one or more weights associated with the second model using the one or more gradients, the one or more gradients being obtained based on inputting one or more activations and one or more inputs into the function.

Some aspects described herein relate to a first device for wireless communication. The first device may include one or more memories and one or more processors coupled to the one or more memories. The one or more processors may be configured to train a first model based on one or more inputs to obtain a trained first model, the trained first model being associated with one or more activations associated with an output of the trained first model. The one or more processors may be configured to transmit, to a second device a function associated with the trained first model, the function being configured to output one or more activations based on a ground truth input.

Some aspects described herein relate to a method of wireless communication performed by a first device. The method may include receiving, from a second device, a function associated with a trained first model, the function being configured to output one or more gradients associated with the trained first model. The method may include training a second model based on selecting one or more weights associated with the second model using the one or more gradients, the one or more gradients being obtained based on inputting one or more activations and one or more inputs into the function.

Some aspects described herein relate to a method of wireless communication performed by a first device. The method may include training a first model based on one or more inputs to obtain a trained first model, the trained first model being associated with one or more activations associated with an output of the trained first model. The method may include transmitting, to a second device, a function associated with the trained first model, the function being configured to output one or more activations based on a ground truth input.

Some aspects described herein relate to a non-transitory computer-readable medium that stores a set of instructions for wireless communication by a first device. The set of instructions, when executed by one or more processors of the first device, may cause the first device to receive, from a second device, a function associated with a trained first model, the function being configured to output one or more gradients associated with the trained first model. The set of instructions, when executed by one or more processors of the first device, may cause the first device to train a second model based on selecting one or more weights associated with the second model using the one or more gradients, the one or more gradients being obtained based on inputting one or more activations and one or more inputs into the function.

Some aspects described herein relate to a non-transitory computer-readable medium that stores a set of instructions for wireless communication by a first device. The set of instructions, when executed by one or more processors of the first device, may cause the first device to train a first model based on one or more inputs to obtain a trained first model, the trained first model being associated with one or more activations associated with an output of the trained first model. The set of instructions, when executed by one or more processors of the first device, may cause the first device to transmit, to a second device, a function associated with the trained first model, the function being configured to output one or more activations based on a ground truth input.

Some aspects described herein relate to an apparatus for wireless communication. The apparatus may include means for receiving, from a second device, a function associated with a trained first model, the function being configured to output one or more gradients associated with the trained first model. The apparatus may include means for training a second model based on selecting one or more weights associated with the second model using the one or more gradients, the one or more gradients being obtained based on inputting one or more activations and one or more inputs into the function.

Some aspects described herein relate to an apparatus for wireless communication. The apparatus may include means for training a first model based on one or more inputs to obtain a trained first model, the trained first model being associated with one or more activations associated with an output of the trained first model. The apparatus may include means for transmitting, to a second device, a function associated with the trained first model, the function being configured to output one or more activations based on a ground truth input.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment in a wireless network, in accordance with the present disclosure.

FIG. 3 is a diagram illustrating an example disaggregated base station architecture, in accordance with the present disclosure.

FIG. 4 is a diagram illustrating an example architecture of a functional framework for radio access network intelligence enabled by data collection, in accordance with the present disclosure.

FIG. 5 is a diagram illustrating an example architecture associated artificial intelligence/machine learning (AI/ML) based channel state feedback compression, in accordance with the present disclosure.

FIG. 6 is a diagram illustrating an example associated with multi-vendor AI/ML training, in accordance with the present disclosure.

FIGS. 7A and 7B are diagrams illustrating examples associated with concurrent training for encoder and decoder models, in accordance with the present disclosure.

FIG. 8 is a diagram illustrating an example associated with sequential training for encoder and decoder models, in accordance with the present disclosure.

FIGS. 9A and 9B are diagrams illustrating examples associated with vector quantization, in accordance with the present disclosure.

FIG. 10 is a diagram of an example associated with hybrid sequential training for encoder and decoder models, in accordance with the present disclosure.

FIG. 11 is a diagram of an example associated with hybrid sequential training for encoder and decoder models, in accordance with the present disclosure.

FIG. 12 is a diagram illustrating an example process performed, for example, by a first device, in accordance with the present disclosure.

FIG. 13 is a diagram illustrating an example process performed, for example, by a first device, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

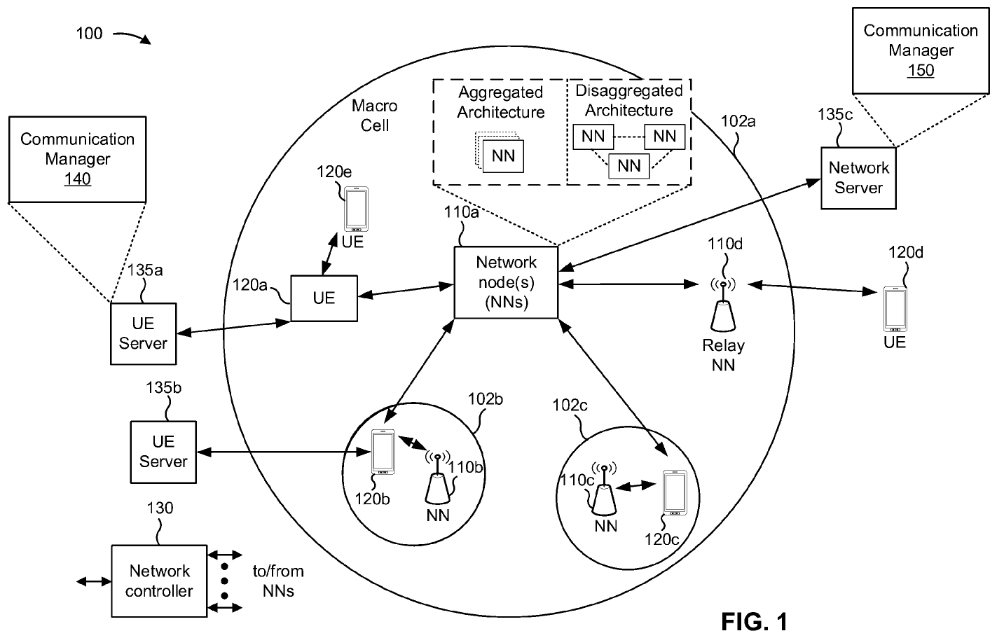

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an cMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic arca in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

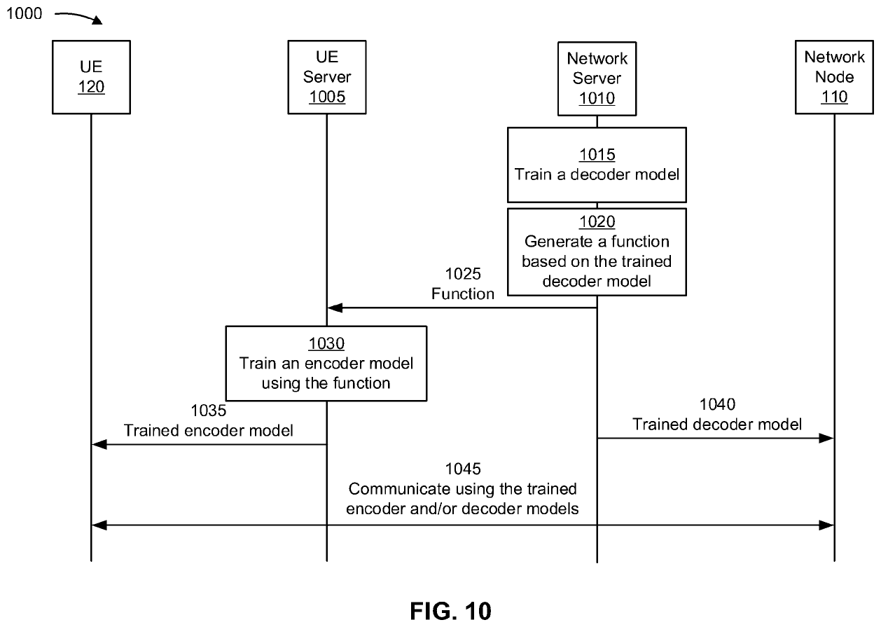

In some examples, the wireless network 100 may include one or more servers, such as servers 135a, 135b, and 135c. In some examples, servers 135a, 135b, and 135c may be wirelessly or otherwise connected, such as connected via a wired connection. Servers 135a, 135b, and 135c may be UE-side servers and may communicate with one or more UEs, such as UEs 120a, 120b, and/or 120c. For example, server 135a may be a UE-side server associated with a first UE vendor and may communicate with the UE 120a (e.g., a UE associated with the first UE vendor). Server 135b may be a second UE-side server associated with a second UE vendor different from the first UE vendor and may communicate with the UE 120b (e.g., the UE 120b may be associated with the second UE vendor). A vendor may be a manufacturer or entity that designs, markets, maintains, and/or sells, among other examples, a device (such as a UE or a network node) or one or more components of the device. Server 135b may have similar functionality to server 135a, as described in more detail elsewhere herein, such as in connection with FIGS. 10-15. Server 135c may be a network-side server and may communicate with one or more network nodes, such as the network node 110a. The servers 135a, 135b, and 135c may also communicate with each other. Servers 135a, 135b, and 135c may communicate using a variety of wireless or wired technologies, such as ethernet, Wi-Fi, or cellular technologies. For example, servers 135a and 135b may each host and train encoders, such as by using one or more machine learning (ML) algorithms, for use by one or more UEs in encoding information, such as sensed channel state feedback from reference signals transmitted by one or more network nodes, as described in more detail elsewhere herein. Server 135c may host and train a decoder, such as by using one or more ML algorithms, for use by one or more network nodes in decoding information, as described in more detail elsewhere herein. In some examples, UE servers and network servers may work together to train an encoder for use by UEs in encoding information for transmission to a network node. For example, server 135a may provide server 135c with input information, such as sensed channel state feedback, received by the server 135a from one or more UEs. The server 135c may train a decoder and an encoder using the received input information, and may provide the server 135a with training information for use by the server 135a in training an encoder to be provided to one or more UEs. Server 135a may train an encoder using the training information and may transmit encoder parameters for the trained encoder to one or more UEs, such as the UE 120a, for use in encoding information to be transmitted to a network node.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz.-7.125 GHZ) and FR2 (24.25 GHZ-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz.-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ.-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a server (e.g., the server 135a, 135b, and/or 135c) may include a communication manager 140. A server may also be referred to as a “server device” herein. As described in more detail elsewhere herein, the communication manager 140 may receive, from another server, a function associated with a trained first model, the function being configured to output one or more gradients associated with the trained first model; and train a second model based on selecting one or more weights associated with the second model using the one or more gradients, the one or more gradients being obtained based on inputting one or more activations and one or more inputs into the function. Additionally, or alternatively, the communication manager 140 may perform one or more other operations described herein.

In some aspects, a server (e.g., the server 135a, 135b, and/or 135c) may include a communication manager 150. As described in more detail elsewhere herein, the communication manager 150 may train a first model based on one or more inputs to obtain a trained first model, the trained first model being associated with one or more activations associated with an output of the trained first model; and transmit, to another server, a function associated with the trained first model, the function being configured to output one or more activations based on a ground truth. Additionally, or alternatively, the communication manager 150 may perform one or more other operations described herein.

As indicated above, FIG. 1 is provided as an example. Other examples may differ from what is described with regard to FIG. 1.

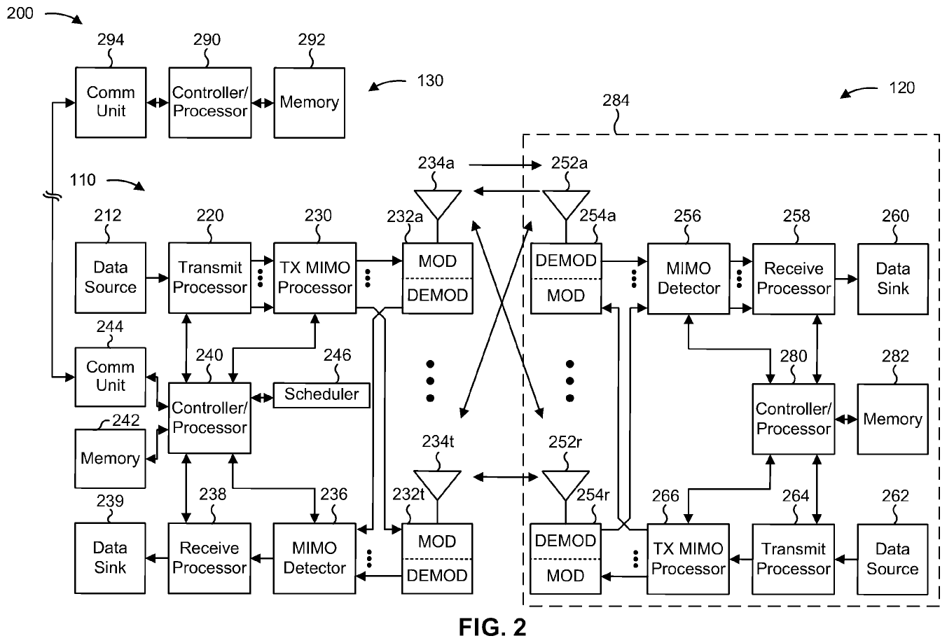

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 10-15).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 10-15).

Reference to an element in the singular is not intended to mean only one unless specifically so stated, but rather “one or more.” For example, reference to an element (e.g., “a processor,” “a controller,” “a memory,” etc.), unless otherwise specifically stated, should be understood to refer to one or more elements (e.g., “one or more processors,” “one or more controllers,” and/or “one or more memories,” among other examples). Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

In some examples, a server described herein (e.g., a network server, a UE server, the server 135a, 135b, and/or 135c) may include a bus, a processor, a memory, an input component, an output component, and/or a communication component. The bus may include one or more components that enable wired and/or wireless communication among the components of the server. For example, the bus may include an electrical connection (e.g., a wire, a trace, and/or a lead) and/or a wireless bus. The processor may include a central processing unit, a graphics processing unit, a microprocessor, a controller, a microcontroller, a digital signal processor, a field-programmable gate array, an application-specific integrated circuit, and/or another type of processing component. The processor may be implemented in hardware, firmware, or a combination of hardware and software. In some examples, the processor may include one or more processors capable of being programmed to perform one or more operations or processes described elsewhere herein.

The memory may include volatile and/or nonvolatile memory. For example, the memory may include random access memory (RAM), read only memory (ROM), a hard disk drive, and/or another type of memory (e.g., a flash memory, a magnetic memory, and/or an optical memory). The memory may include internal memory (e.g., RAM, ROM, or a hard disk drive) and/or removable memory (e.g., removable via a universal serial bus connection). The memory may be a non-transitory computer-readable medium. The memory may store information, one or more instructions, and/or software (e.g., one or more software applications) related to the operation of the server. The input component may enable the server to receive input, such as user input and/or sensed input. For example, the input component may include a touch screen, a keyboard, a keypad, a mouse, a button, a microphone, a switch, a sensor, a global positioning system sensor, an accelerometer, a gyroscope, and/or an actuator, among other examples. The output component may enable the server to provide output, such as via a display, a speaker, and/or a light-emitting diode. The communication component may enable the server to communicate with other devices via a wired connection and/or a wireless connection. For example, the communication component may include a receiver, a transmitter, a transceiver, a modem, a network interface card, and/or an antenna.

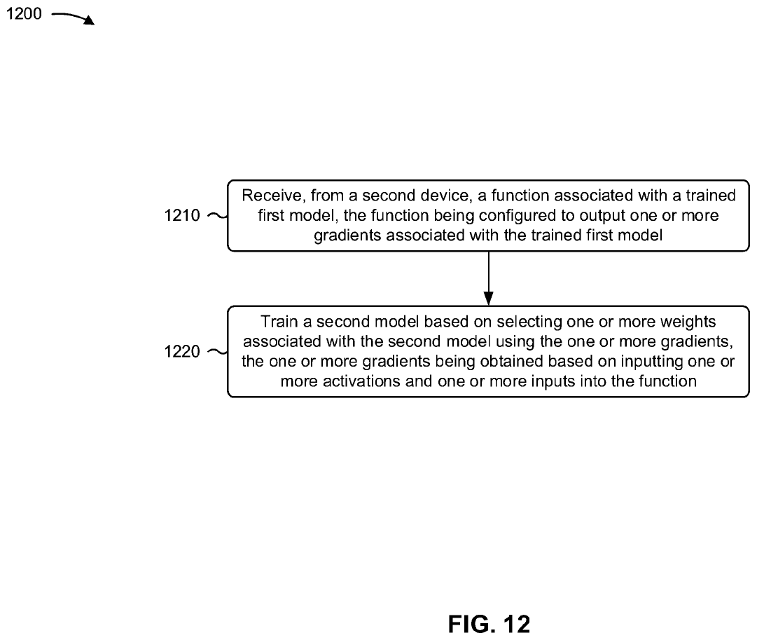

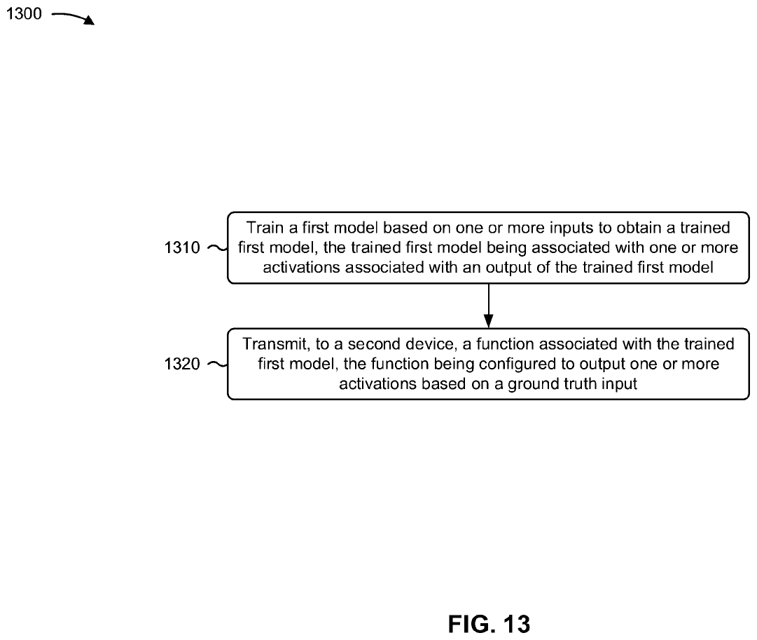

The server may perform one or more operations or processes described herein, for example, process 1200 of FIG. 12, process 1300 of FIG. 13, and/or other processes as described herein. For example, a non-transitory computer-readable medium (e.g., the memory) may store a set of instructions (e.g., one or more instructions or code) for execution by the processor. The processor may execute the set of instructions to perform one or more operations or processes described herein. In some implementations, execution of the set of instructions, by one or more processors, causes the one or more processors and/or the server to perform one or more operations or processes described herein. In some implementations, hardwired circuitry may be used instead of or in combination with the instructions to perform one or more operations or processes described herein. Additionally, or alternatively, the processor of the server may be configured to perform one or more operations or processes described herein, for example, process 1200 of FIG. 12, process 1300 of FIG. 13, and/or other processes as described herein. Thus, implementations described herein are not limited to any specific combination of hardware circuitry and software.

The controller/processor 240 of the network node 110, the controller/processor 280 of the UE 120, and/or any other component(s) of FIG. 2 may perform one or more techniques associated with hybrid sequential training for encoder and decoder models, as described in more detail elsewhere herein. In some aspects, a server described herein is the network node 110, is included in the network node 110, or includes one or more components of the network node 110 shown in FIG. 2. In some other aspects, a server described herein is the UE 120, is included in the UE 120, or includes one or more components of the UE 120 shown in FIG. 2. In other aspects, a server described herein may be a separate device from a network node 110 and/or a UE 120 and may be configured to communicate with the network node 110 and/or the UE 120.

For example, the controller/processor 240 of the network node 110, the controller/processor 280 of the UE 120, a controller/processor of a server, and/or any other component(s) of FIG. 2 may perform or direct operations of, for example, process 1200 of FIG. 12, process 1300 of FIG. 13, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of a server, the network node 110 and/or the UE 120, may cause the one or more processors, the server, the UE 120, and/or the network node 110 to perform or direct operations of, for example, process 1200 of FIG. 12, process 1300 of FIG. 13, and/or other processes as described herein. In some examples, executing instructions may include running the instructions, converting the instructions, compiling the instructions, and/or interpreting the instructions, among other examples.

In some aspects, a server (e.g., the server 135a, 135b, and/or 135c) includes means for receiving, from another device, a function associated with a trained first model, the function being configured to output one or more gradients associated with the trained first model; and/or means for training a second model based on selecting one or more weights associated with the second model using the one or more gradients, the one or more gradients being obtained based on inputting one or more activations and one or more inputs into the function. In some aspects, the means for the server to perform operations described herein may include, for example, one or more of communication manager 140, an antenna, a modem, a MIMO detector, a receive processor, a transmit processor, a TX MIMO processor, a controller/processor, an input component, an output component, a communication component, and/or a memory, among other examples.

In some aspects, a server (e.g., a network server, a UE server, the server 135a, 135b, and/or 135c) includes means for training a first model based on one or more inputs to obtain a trained first model, the trained first model being associated with one or more activations associated with an output of the trained first model; and/or means for transmitting, to a second device, a function associated with the trained first model, the function being configured to output one or more activations based on a ground truth input. In some aspects, the means for the server to perform operations described herein may include, for example, one or more of communication manager 150, an antenna, a modem, a MIMO detector, a receive processor, a transmit processor, a TX MIMO processor, a controller/processor, an input component, an output component, a communication component, and/or a memory, among other examples.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or onc or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

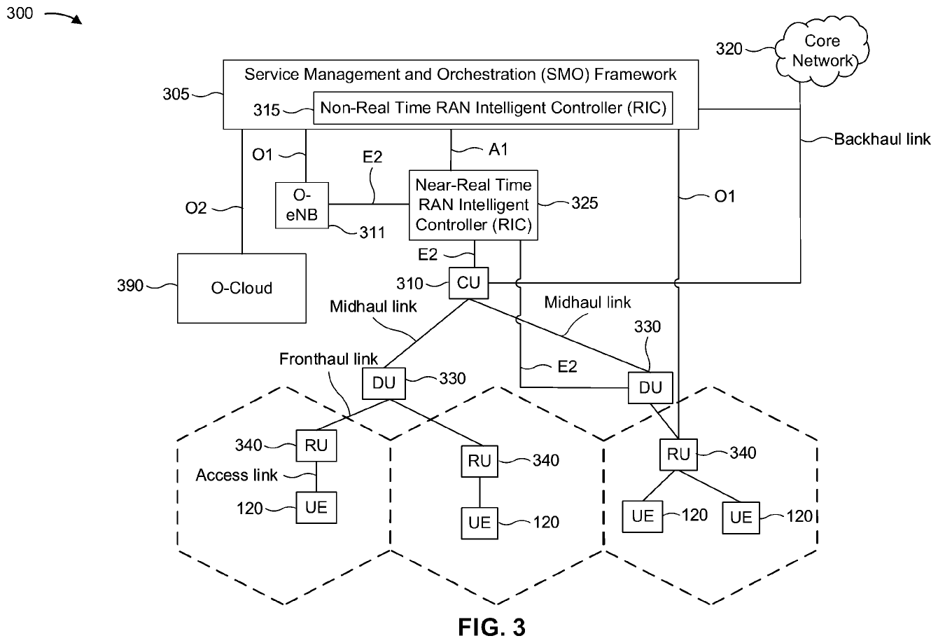

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an 01 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policics).

As indicated above, FIG. 3 is provided as an example. Other examples may differ from what is described with regard to FIG. 3.

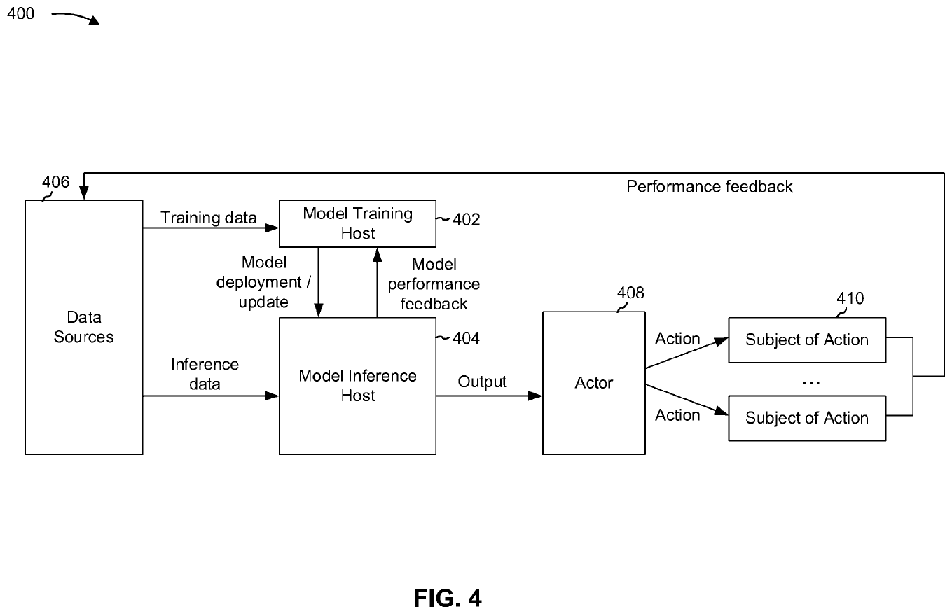

FIG. 4 is a diagram illustrating an example architecture 400 of a functional framework for radio access network (RAN) intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., compression, beam management, energy saving, load balancing, mobility management, and/or coverage optimization, among other examples). In one example, as shown by the architecture 400, a functional framework for RAN intelligence may include multiple logical entities, such as a model training host 402, a model inference host 404, data sources 406, and an actor 408.

The model inference host 404 may be configured to run an AI/ML model based on inference data provided by the data sources 406. The model inference host 404 may produce an output (e.g., a prediction) with the inference data input to the actor 408. The actor 408 may be an element or an entity of a core network or a RAN. For example, the actor 408 may be a UE, a network node, base station (e.g., a gNB), a CU, a DU, and/or an RU, among other examples. In addition, the actor 408 may also depend on the type of tasks performed by the model inference host 404, type of inference data provided to the model inference host 404, and/or type of output produced by the model inference host 404, among other examples. For example, if the output from the model inference host 404 is associated with beam management, then the actor 408 may be a UE, a DU or an RU. In other examples, if the output from the model inference host 404 is associated with Tx/Rx scheduling, then the actor 408 may be a CU or a DU.

After the actor 408 receives an output from the model inference host 404, the actor 408 may determine whether to act based on the output. For example, if the actor 408 is a DU or an RU and the output from the model inference host 404 is associated with beam management, the actor 408 may determine whether to change and/or modify a Tx/Rx beam based on the output. If the actor 408 determines to act based on the output, the actor 408 may indicate the action to at least one subject of action 410. For example, if the actor 408 determines to change/modify a Tx/Rx beam for a communication between the actor 408 and the subject of action 410 (e.g., a UE 120), then the actor 408 may transmit a beam (re-)configuration or a beam switching indication to the subject of action 410. The actor 408 may modify its Tx/Rx beam based on the beam (re-)configuration, such as switching to a new Tx/Rx beam or applying different parameters for a Tx/Rx beam, among other examples. As another example, the actor 408 may be a UE and the output from the model inference host 404 may be associated with beam management. For example, the output may be one or more predicted measurement values for one or more beams. The actor 408 (e.g., a UE) may determine that a measurement report (e.g., a Layer 1 (L1) RSRP report) is to be transmitted to a network node 110.

The data sources 406 may also be configured for collecting data that is used as training data for training an ML model or as inference data for feeding an ML model inference operation. For example, the data sources 406 may collect data from one or more core network and/or RAN entities, which may include the subject of action 410, and provide the collected data to the model training host 402 for ML model training. For example, after a subject of action 410 (e.g., a UE 120) receives a beam configuration from the actor 408, the subject of action 410 may provide performance feedback associated with the beam configuration to the data sources 406, where the performance feedback may be used by the model training host 402 for monitoring or evaluating the ML model performance, such as whether the output (e.g., prediction) provided to the actor 408 is accurate. In some examples, if the output provided by the actor 408 is inaccurate (or the accuracy is below an accuracy threshold), then the model training host 402 may determine to modify or retrain the ML model used by the model inference host, such as via an ML model deployment/update.

In cross-node machine learning, a neural network may be split into two portions, where a first portion includes an encoder of a UE, and a second portion includes a decoder of a network node. The encoder output of the UE may be transmitted to the network node as an input to the decoder. For example, an input to the encoder may be channel state information (CSI), such as one or more channel estimations, one or more precoders (e.g., one or more precoding vectors), and/or one or more measurement values, among other examples. The encoder may use a trained AI/ML model to compress the CSI. The output of the encoder model (e.g., the trained AI/ML model) may be transmitted to the network node. The network node may input the received information into the decoder of the network node. The decoder may use a trained AI/ML model to attempt to reconstruct the CSI (e.g., that was input to the encoder at the UE). To evaluate the machine learning based CSI compression use cases, one or more different types of quantization or dequantization methods may be used, such as vector quantization and/or scalar quantization, among other examples. In CSI compression using two-sided model use cases, multiple machine learning model trainings may be utilized.

UEs and network nodes designed, marketed, and maintained by different vendors may implement different encoders and decoders for encoding and decoding information, such as channel state feedback information. A UE server (e.g., the server 135a or the server 135b) may train an encoder for implementation by one or more UEs, offline, such as by applying one or more ML algorithms to train the encoder. The UE server may, for example, be operated and maintained by a particular UE vendor, and may determine encoder parameters for transmission to one or more UEs associated with the particular UE vendor. In some cases, one or more UEs for which the encoder is being trained may transmit input information, such as channel state feedback information, to the UE server.

The UE server may transmit such input information to a network server, such as the server 135c. The network server may train a decoder for implementation by one or more network nodes offline, such as by applying one or more ML algorithms to train the decoder. The network server may, for example, be operated and maintained by a particular network node vendor, and may determine decoder parameters to be provided to one or more network nodes associated with the particular network node vendor. In some cases, one or more network nodes for which the decoder is being trained may transmit input information, such as channel state feedback information, to the network server. The network server may further supervise training of encoders by one or more UE servers. For example, the network server may receive input information from one or more UE servers, or from another source, and may use the input information to train both an encoder and a decoder. The network server may then encode the input information using the trained encoder to generate training information. The training information may include both the input information and the output of the encoder, such as encoded input information. The network server may transmit the training information to one or more UE servers. The one or more UE servers may use the training information to perform offline training of the encoder of each respective UE server. Such training may produce one or more encoder parameters for use by one or more UEs in encoding information, and the encoder parameters may be transmitted by the one or more UE-side servers to one or more UEs.

As indicated above, FIG. 4 is provided as an example. Other examples may differ from what is described with regard to FIG. 4.

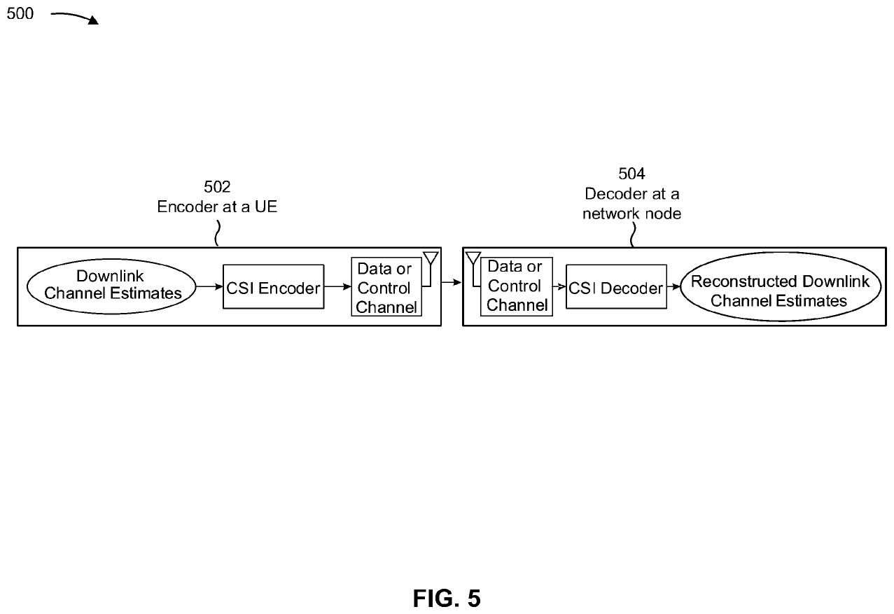

FIG. 5 is a diagram illustrating an example architecture 500 associated AI/ML based channel state feedback compression, in accordance with the present disclosure. As described elsewhere herein, in cross-node machine learning, a neural network may be split into two portions, where a first portion includes an encoder 502 of a UE, and a second portion includes a decoder 504 of a network node. The encoder may include an encoder model that is an AI/ML model trained to compress CSI. The encoder output at the UE is transmitted to the network node to be provided as an input to the decoder. The decoder may include a decoder model that is an AI/ML model trained to reconstruct or decompress CSI.

As shown in FIG. 5, the encoder 502 may output compressed channel state feedback (CSF) or another data signal, which is received as input at the decoder 504. The decoder 504 may output a reconstructed CSF (e.g., decompressed CSF) or another data signal, such as precoding vectors, among other examples. In multi-vendor training, each vendor (e.g., UE vendor or network node vendor) may be associated with a corresponding server that participates in offline training. The UE server(s) (e.g., the server 135a and/or the server 135b) may communicate with network server(s) (e.g., the server 135c) during the training using server-to-server connections.

In CSI compression using two-sided model use cases, multiple machine learning model trainings may be utilized. In some examples, joint training of the two-sided model at a single side/entity (e.g., UE-sided or network-sided) may be utilized. In some examples, joint training of the two-sided model at a network side and a UE side, respectively, may be utilized. In yet some other examples, separate training at a network side and a UE side, where the UE side CSI generation part and the network side CSI reconstruction part are trained by the UE side and the network side, respectively, may be utilized (e.g., the separate training may also be referred to as sequential training). “Joint training” may refer to the generation model and reconstruction model being trained in the same loop for forward propagation and backward propagation. Joint training may be done both at a single node or across multiple nodes (e.g., through gradient exchange between nodes or servers). Separate training may include sequential training starting with the UE side training, or sequential training starting with the network side training, or parallel training by a UE server and a network server.

As indicated above, FIG. 5 is provided as an example. Other examples may differ from what is described with regard to FIG. 5.

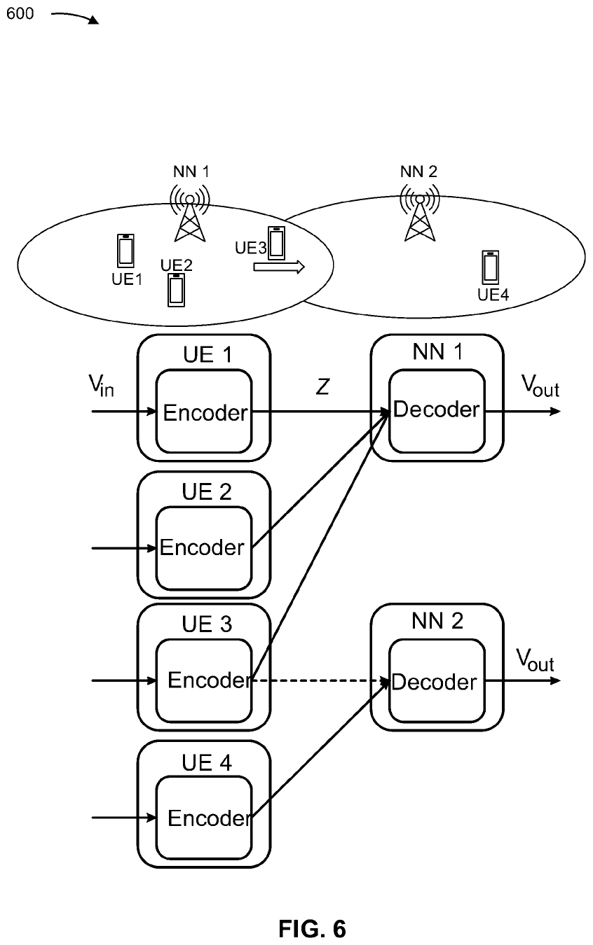

FIG. 6 is a diagram illustrating an example 600 associated with multi-vendor AI/ML training, in accordance with the present disclosure.

For example, as shown in FIG. 6, a first network node (NN 1) (e.g., a network node 110) may be associated with a first cell and a second network node (NN 2) (e.g., a network node 110) may be associated with a second cell. Multiple UEs 120 (e.g., UE 1, UE 2, UE 3, UE4) may be within a coverage area of the NN 1 and/or the NN 2. In instances without multi-vendor training, each UE-network node pair may need to utilize different encoder-decoder pairs. Multi-vendor training eliminates the need to utilize different encoder-decoder pairs for each UE-network node pairing. For example, in instances of multi-UE vendors with one network node vendor, a common network node decoder may be trained to work with multiple UE encoders. Consequently, the network node (e.g., NN 1) may not need to maintain a separate decoder model for each UE that is located within a coverage area of a cell of the network node. In examples of a single-UE vendor with multi-network node vendors, a common UE encoder may be trained to work with multiple network node decoders. In such examples, the UE may not need to maintain a separate encoder model for each network node (e.g., such as when the UE moves to a new cell). In examples of multi-UE vendors with multi-network node vendors, the UE encoder may be trained to work with multiple network node decoders, while the network node decoder may be trained to work with multiple UE encoders. For example, as shown in FIG. 6, the respective encoders of UE 1 and UE 2 may be trained to work with the decoder of the NN 1, while the encoder of UE 4 may be trained to work with the decoder of the NN 2. However, the UE 3 may be at a cell edge and between the NN 1 and the NN 2, such that the encoder of UE 3 may be trained to work with the decoder both the NN 1 and the NN 2. In other words, as the UE 3 moves from a coverage area of the NN 1 to a coverage area of the NN 2, the UE 3 may deploy the same encoder model to communicate with the NN 1 and the NN 2 (e.g., where the NN 1 and the NN 2 may be associated with different vendors and/or different decoder models). This may reduce a training overhead and/or a complexity associated with the AI/ML based CSI compression described herein because a UE may not need to maintain multiple encoder models for different network node vendors and/or for different network node decoder models. Additionally, or alternatively, a network node may not need to maintain multiple decoder models for different UE vendors and/or for different UE encoder models.

As indicated above, FIG. 6 is provided as an example. Other examples may differ from what is described with regard to FIG. 6.

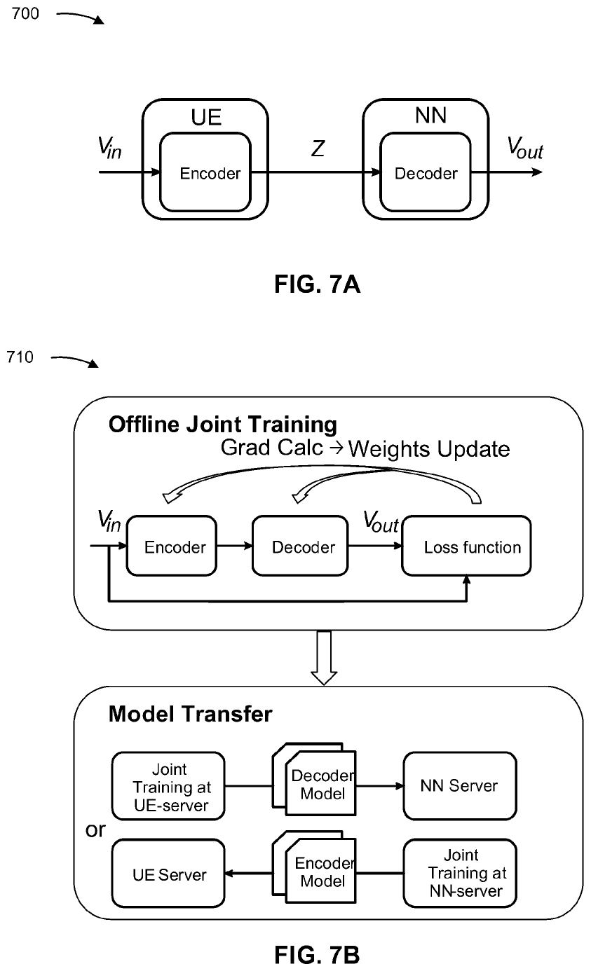

FIGS. 7A and 7B are diagrams illustrating examples 700 and 710 associated with concurrent training for encoder and decoder models, in accordance with the present disclosure. As used herein, joint training or concurrent training that occurs at a single device may be referred to as type 1 training. For example, type 1 training may be associated with joint training of a two-sided model (e.g., an encoder model and a decoder model) at a single side/entity.

As shown in FIG. 7A, an input or ground truth may be provided to the encoder model at the UE (e.g., shown as Vin in FIG. 7A). For example, the input may include CSI as described in more detail elsewhere herein. The Vin may be compressed by the encoder model. The encoder model may output an activation or an activation function (e.g., shown as Z in FIG. 7A). “Activation function” or “activation” may refer to an output of a neural network (e.g., of the encoder model). For example, an activation function of a node of a neural network defines an output of the node given an input or set of inputs. The UE may transmit, and the network node may receive, the activation function, Z. The network node may provide the activation function, Z, as an input to the decoder model. The decoder model may provide an output (e.g., shown as Vour in FIG. 7A). The output may be a reconstruction of the Vin and/or a decompression of the activation function, Z.

As shown in FIG. 7B, the example 710 depicts type 1 training and model transfer. For example, a device (e.g., a UE server or a network server) may train the encoder model and the decoder model. The device may provide the Vᵢₙ and Vₒᵤₜ to a loss function that determines the difference between the original input Vᵢₙ of the encoder and the reconstructed version of the original input Vom of the decoder. A gradient may be calculated based on the loss function, and the weights of the encoder or decoder may be updated to train the encoder or decoder. As shown in FIG. 7B, if the joint training occurs at a UE server, then the UE server may transmit, and a network server may receive, an indication of the trained decoder model (e.g., to be provided to one or more network nodes by the network server). As another example, if the joint training occurs at a network server, the network server may transmit, and a UE server may receive, an indication of the trained encoder model (e.g., to be provided to one or more UEs by the UE server).

In concurrent training (e.g., type 1 training), both the encoder and the decoder may be trained jointly, such that the model weights of the encoder and decoder can be both optimized jointly. In offline concurrent training, models may be trained offline and may be provided to cither the network node or the UE. However, one-sided concurrent training may allow for the trained models to be exposed to the network node or the UE. Joint training may occur at a UE server or a network server. For example, a UE vendor may train both the encoder and decoder models using its own data set and may share the trained decoder model with the network server (e.g., that is associated with a different vendor than the UE vendor). The decoder model shared with the other vendor may reveal or provide relevant information related to implementation details of components of the UE (e.g., such as a modem of the UE). Similarly, in examples where a network server trains both the encoder and the decoder models, the shared encoder model may reveal or provide relevant information related to implementation details of components of the network node. This information may be revealed due in part to symmetry that typically exists between the encoder and the decoder. Consequently, the trained encoder and decoder may be a trade secret or include proprietary information that a vendor may not want to reveal to another vendor.

In some other examples, the encoder model and the decoder model may be trained concurrently (e.g., where the encoder model and the decoder model are trained in the same loop for forward propagation and backward propagation) at different devices. For example, a UE server may train the encoder model and a network server may train the decoder model. Concurrent training at different devices may be referred to as type 2 training. For example, type 2 training may include joint training of a two-sided model (e.g., a decoder and an encoder) at the network side and the UE side, respectively. For example, for each forward propagation loop and/or each backward propagation loop, the UE server may generate forward propagation results (e.g., may generate Z based on providing Vᵢₙ to the encoder model). For example, one or more UEs may provide data (e.g., CSI) to the UE server to be used to train the encoder and/or the decoder. The UE server may transmit the forward propagation results (e.g., Z and Vᵢₙ) to the network server. The network server may obtain Vₒᵤₜ based on providing Z to the decoder model. The network server may generate backward propagation results (e.g., gradients) based on a loss function that compares the Vₒᵤₜ to the Vᵢₙ. The network server may transmit, and the UE server may receive, the backward propagation results (e.g., gradients). The UE server may train the encoder model based on the backward propagation results (e.g., gradients). For example, the UE server may update one or more weights of a neural network of the encoder model based on the backward propagation results (e.g., gradients). After training the models, the UE sever may transmit, to one or more UEs, the trained encoder model. Similarly, the network server may transmit, to one or more network nodes, the trained decoder model. The UE(s) and network node(s) may perform inferences using the trained models, as described in more detail elsewhere herein.

The type 2 training ensures that confidential and/or proprietary information is not shared between the UE server and the network server during training (e.g., using distributed training at different devices, rather than at a single device as in type 1 training). Additionally, the type 2 training may be associated with improved training of the models because the models are trained concurrently and in the same loop for forward propagation and backward propagation. However, type 2 training is performed concurrently at different devices. For example, a training session may be established between a UE server and a network server to perform the type 2 training. Therefore, the type 2 training may be associated with restrictions as to the timing of the training (e.g., because a training session between the UE server and the network server is needed to perform the type 2 training).

As indicated above, FIGS. 7A and 7B are provided as examples. Other examples may differ from what is described with regard to FIGS. 7A and 7B.

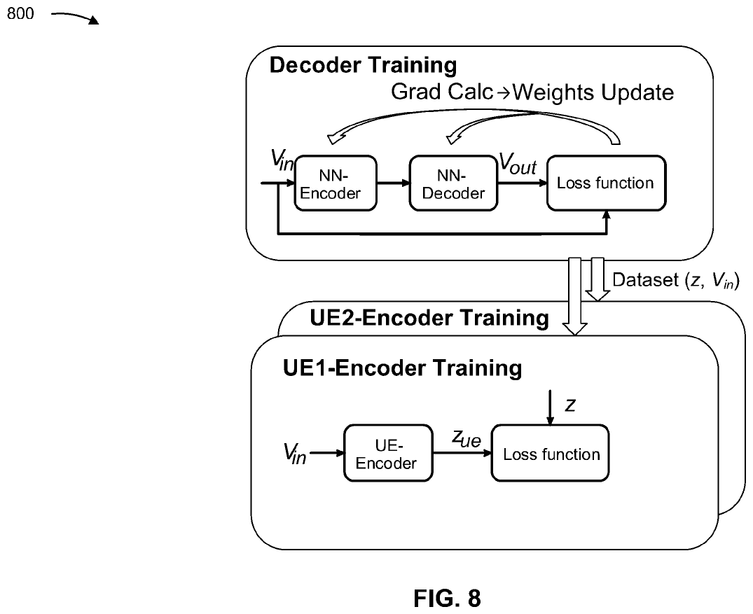

FIG. 8 is a diagram illustrating an example 800 associated with sequential training for encoder and decoder models, in accordance with the present disclosure. As used herein, sequential training or separate training may be referred to as type 3 training. For example, type 3 training may be associated with separate training of a two-sided model (e.g., an encoder model and a decoder model) at different entities. For example, FIG. 8 depicts network drive sequential training. However, type 3 training may include UE driven (e.g., UE server driven) sequential training in a similar manner as described herein.

As shown in FIG. 8, multiple UE encoders may be trained based on a trained network node decoder. For example, a network server may be trained in a similar manner as described in connection with FIGS. 7A and 7B (e.g., using an encoder model at the network server). The network server may transmit, and a UE server may receive, a data set. The data set may include one or more inputs (e.g., one or more Vᵢₙ and/or one or more outputs of the encoder (e.g., one or more Z functions) that were used to train the decoder model. This may enable different UE servers to train encoder models using the data set. For example, as shown in FIG. 8, a UE server may provide a Vᵢₙ from the data set as an input to the encoder model. The UE server may provide, to a loss function, the output obtained from the encoder model (e.g., Z_{UE}) and an output (e.g., Z) corresponding to the input (e.g., Vᵢₙ) from the data set. The loss function may output a gradient that is used by the UE server to update one or more weights of the encoder model, as described in more detail elsewhere herein. For example, training the UE encoder may be achieved by minimizing a loss between Z (e.g., output of the network node encoder) with Z_{UE} which is the output of the UE encoder. Therefore, the type 3 training enables offline separate training at different devices. Additionally, the type 3 training can occur at different times at different devices, providing additional flexibility to the training of the encoder and decoder models (e.g., as compared to the type 2 training described elsewhere herein).

As indicated above, FIG. 8 is provided as an example. Other examples may differ from what is described with regard to FIG. 8.

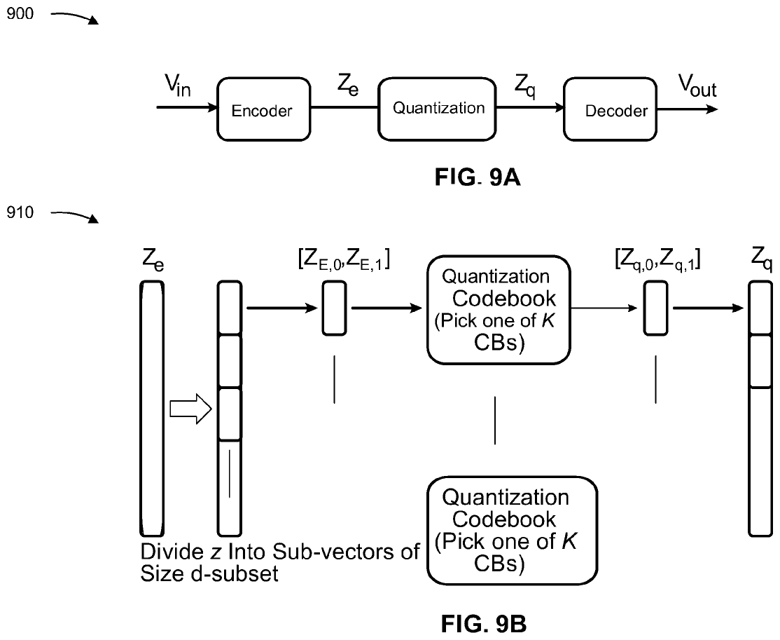

FIGS. 9A and 9B are diagrams illustrating examples 900 and 910 associated with vector quantization, in accordance with the present disclosure.

In vector quantization, an input vector may be quantized and mapped to one or more vectors in a quantization codebook. In some examples, the quantization codebook may include vectors of size 2 or 4 where each entry may be represented by 2 bits or another quantity of bits. However, in other examples, the quantization codebook may include vectors of different sizes.

As shown in FIG. 9A, an input Vᵢₙ may be input into an encoder model, which produces an encoder output Z_{E}. The output Z_{E} may be quantized to produce a quantized output Z_{q}. The quantized output Z_{q} may be processed by a decoder model in an effort to reconstruct the Vᵢₙ, where the decoder output is Vₒᵤₜ. As shown in FIG. 9B, to perform the quantization, a quantizer may receive the encoder output Z_{E} and divide Z_{E} into sub-vectors of size d-subset (e.g., 2 or 4). A sub-vector (e.g., Z_{E,0}, Z_{E,1}) is quantized based on a quantization codebook to produce a quantized sub-vector (e.g., Z_{q,0}, Z_{q,1}), where the quantized sub-vector is mapped to one of the vectors in the codebook. To perform the mapping based on the codebook, the quantizer maps the values of the quantized sub-vector to two values of the codebook (e.g., one of K values of the codebook). For example, the quantizer may map the inputs to the closest quantized value of the codebook. The quantized sub-vectors are then merged to form the quantized output Z_{q}.

As indicated above, FIGS. 9A and 9B are provided as examples. Other examples may differ from what is described with regard to FIGS. 9A and 9B.

As described above, different training techniques may be used to train encoder models and decoder models for CSI compression. For example, the type 2 training may be used to ensure that confidential and/or proprietary information is not shared between the UE server and the network server during training (e.g., using distributed training at different devices, rather than at a single device, such as in type 1 training). However, type 2 training is performed concurrently at different devices. For example, a training session may be established between a UE server and a network server to perform the type 2 training. Therefore, the type 2 training may be associated with restrictions as to the timing of the training (e.g., because a training session between the UE server and the network server is needed to perform the type 2 training). The type 3 training may be used to provide additional flexibility in the timing at which the training is performed (e.g., by performing separate training at different devices). However, in some cases, the type 2 training may be associated with improved results and/or accuracy of the trained models as compared to the type 3 training (e.g., because the models in type 2 training are trained concurrently and in the same loop for forward propagation and backward propagation, rather than using the data sets described above). Therefore, device(s) performing the training may choose between either improved results and/or accuracy of training (e.g., by performing type 2 training) or increased flexibility as to the timing at which the training occurs (e.g., by performing type 3 training).

Some techniques and apparatuses described herein enable a hybrid sequential training for encoder and decoder models. For example, a first device may transmit, and a second device may receive, an indication of a function associated with a trained model (e.g., a trained encoder model or a trained decoder model) that is associated with the first device. For example, the first device may train the first model offline in a similar manner to type 3 training. The first device may transmit, to a second device, the function that simulates a forward propagation path and a backward propagation path to facilitate concurrent training of a second model at the second device. For example, the function may be an application programming interface (API), a software program, a set of instructions, code, and/or another function.

For example, the first device may be a network server and the first model may be a decoder model. The second device may be a UE server and the second model may be an encoder model. The network server may transmit, to a UE server, a function that accepts an activation function (e.g., Z) and a ground truth (e.g., Vᵢₙ) as inputs and outputs one or more gradients (e.g., to simulate a backward propagation path of the trained decoder model). The UE server may use the one or more gradients to train an encoder model (e.g., to update one or more weights of the encoder model based at least in part on the one or more gradients). As another example, the first device may be a UE server and the first model may be an encoder model. The second device may be a network server and the second model may be a decoder model. The UE server may transmit, and the network server may receive, a function that receives a ground truth (e.g., Vᵢₙ) as an input and outputs an activation function, Z (e.g., to simulate a forward propagation path of the trained encoder model). The network server may use the activation function and the ground truth to train the decoder model (e.g., by providing the activation function and the ground truth to a loss function and using a gradient of the loss function to update weights of the decoder model).

As a result, the encoder model and the decoder model may be trained using forward propagation paths and backward propagation paths in the same training loop (e.g., in a similar manner as type 2 training) while also being trained sequentially and/or separately. For example, the function provided by the first device to the second device may enable forward propagation paths and backward propagation paths (e.g., that are fixed at the first device) to be simulated at the second device for simulated joint or concurrent training. This may improve an accuracy of the training of the encoder and/or decoder models (e.g., by training concurrently and in the same loop for forward propagation and backward propagation). Additionally, this may increase a flexibility as to a timing at which training occurs (e.g., because the encoder model and the decoder model may be trained separately and/or at different times). For example, a training session may not be established between a UE server and a network server to jointly train the encoder model and the decoder model.

FIG. 10 is a diagram of an example 1000 associated with hybrid sequential training for encoder and decoder models, in accordance with the present disclosure. As shown in FIG. 10, a network node 110 (e.g., a base station, a CU, a DU, and/or an RU) may communicate with a UE 120. In some aspects, the network node 110 and the UE 120 may be part of a wireless network (e.g., the wireless network 100). The UE 120 and the network node 110 may have established a wireless connection prior to operations shown in FIG. 10. As shown in FIG. 10, the UE 120 may communicate with a UE server 1005 (e.g., the server 135a or the server 135b). The UE server 1005 may be associated with a vendor of the UE 120. Similarly, the network node 110 may communicate with a network server 1010 (e.g., the server 135c). The network server 1010 may be associated with a vendor of the network node 110.

As described herein, operations performed by the UE 120 and/or the UE server 1005 may be referred to as “UE-side” operations. Similarly, operations performed by the network node 110 and/or the network server 1010 may be referred to as “network-side” operations. In some aspects, one or more (or all) operations described herein as being performed by the UE server 1005 may be performed by the UE 120. Similarly, one or more (or all) operations described herein as being performed by the network server 1010 may be performed by the network node 110 (or another network node).

In some aspects, actions described herein as being performed by a network node 110 may be performed by multiple different network nodes. For example, configuration actions may be performed by a first network node (for example, a CU or a DU), and radio communication actions may be performed by a second network node (for example, a DU or an RU). As used herein, the network node 110 “transmitting” a communication to the UE 120 may refer to a direct transmission (for example, from the network node 110 to the UE 120) or an indirect transmission via one or more other network nodes or devices. For example, if the network node 110 is a DU, an indirect transmission to the UE 120 may include the DU transmitting a communication to an RU and the RU transmitting the communication to the UE 120. Similarly, the UE 120 “transmitting” a communication to the network node 110 may refer to a direct transmission (for example, from the UE 120 to the network node 110) or an indirect transmission via one or more other network nodes or devices. For example, if the network node 110 is a DU, an indirect transmission to the network node 110 may include the UE 120 transmitting a communication to an RU and the RU transmitting the communication to the DU.

As shown by reference number 1015, the network server 1010 may train a decoder model associated with the network node 110. For example, the network server 1010 may train the decoder model in a similar manner as described elsewhere herein, such as in connection with type 1 training and/or type 3 training. For example, the network server 1010 may receive, from the network node 110, the UE server 1005, and/or one or more UEs 120, one or more data sets to be used as inputs to train the decoder model. For example, the one or more data sets may include CSI. The network server 1010 may deploy an encoder model at the network server 1010. The encoder model may be configured to output an activation function (e.g., Z) based on an input or ground truth provided to the encoder model (e.g., Vᵢₙ). The network server 1010 may provide the activation function as an input to the decoder model. The decoder model may output a Vₒᵤₜ that is a reconstruction of the input or ground truth provided to the encoder model (e.g., Vᵢₙ). The network server 1010 may provide input or ground truth provided to the encoder model (e.g., Vᵢₙ) and the output Vom to a loss function. The loss function may compare the Vᵢₙ to the Vₒᵤₜ. The network server 1010 may obtain a gradient based on an output of the loss function. The network server 1010 may train the decoder model based on the gradient. For example, the network server 1010 may update one or more weights of a neural network of the decoder model using the gradient (e.g., in an attempt to minimize the loss function). The network server 1010 may perform one or more training loops in a similar manner to update the weights of the decoder model until an output of the loss function satisfies a training threshold. For example, the network server 1010 may perform one or more training loops until a difference between the output Vₒᵤₜ of the decoder model sufficiently reconstructs the input or ground truth Vᵢₙ that is provided to the encoder model.

As shown by reference number 1020, the network server 1010 may generate a function based on the trained decoder model. The function may be an API, a set of instructions, code, a software program, and/or another function. The function may be configured to output one or more gradients based on an input of an activation and an input. For example, based on the training of the decoder model, the network server 1010 may configure the function to simulate the forward and backward propagation paths of the decoder model using the information obtained via the training loops and/or based on the loss function. For example, the function may be configured, when executed by a device (such as the UE server 1005), to mimic or simulate the forward and backward propagation paths of the trained decoder model. For example, the function may be configured, when executed by a device, to accept an activation (e.g., Z) and a ground truth (e.g., Vᵢₙ) as inputs and to return a gradient as an output (e.g., which may be used for updating weights of an encoder model, as described in more detail elsewhere herein). In other words, the function may be configured to provide backward propagation path results (e.g., for a training loop) associated with the trained decoder model.

In some aspects, the network server 1010 may generate the function based on training the decoder model. For example, the network server 1010 may determine gradients that are obtained from various activations (e.g., Z) and ground truths (e.g., Vᵢₙ) during the training process of the decoder model. The network server 1010 may configure the function to provide a given gradient based on a given activation and/or ground truth input to the function (e.g., using the information obtained via the training loops and/or based on the loss function, thereby enabling an encoder model to be trained using forward propagation paths and backward propagation paths in the same training loop (e.g., in a similar manner as type 2 training) as the decoder model while also enabling the decoder model and the encoder model to be trained sequentially and/or separately). Additionally, or alternatively, the function may be pre-configured (e.g., by the vendor associated with the network server 1010). In such examples, the network server 1010 may obtain the function from a memory of the network server 1010.

In some aspects, the network server 1010 (and/or the network node 110) may determine a codebook for vector quantization associated with compressed CSI, as described in more detail elsewhere herein (such as in connection with FIGS. 9A and 9B). For example, the network server 1010 (and/or the network node 110) may train a vector quantization model as part of training the decoder model. For example, the network server 1010 (and/or the network node 110) may train a quantizer associated with vector quantization. The quantization codebooks (e.g., vector codebook or scalar codebook) may be determined at the network server 1010 (and/or the network node 110) as part of training of the decoder model. In some aspects, the function (e.g., the API or other function) generated by the network server 1010 may include vector quantization components. For example, the function may be configured to simulate the effects of quantization on activations or other information output by, or input to, the trained decoder model.

In some aspects, the network server 1010 may generate the function to be associated with multiple decoder models. For example, the network server 1010 may train multiple decoder models (e.g., in a similar manner as described in more detail elsewhere herein). In some aspects, the multiple decoder models may be associated with respective UE vendors. As another example, the multiple decoder models may be associated with respective types of CSI (e.g., a first decoder model may be associated with precoding vectors, a second decoder model may be associated with channel estimations, among other examples). As another example, the multiple decoder models may be associated with respective channel conditions. As another example, the multiple decoder models may be associated with respective CSI sizes (e.g., a size of CSI to be communicated between the network node 110 and the UE 120). The network server 1010 may generate the function to be configured to simulate the forward propagation paths and the backward propagation paths of the multiple trained decoder models.

As shown by reference number 1025, the network server 1010 may transmit, and the UE server 1005 may receive, the function (e.g., that is associated with the trained decoder model). For example, the network server 1010 and the UE server 1005 may establish a connection (e.g., a wireless connection or a wired connection). The function may be transmitted from the network server 1010 to the UE server 1005 via the connection.

As shown by reference number 1030, the UE server 1005 may train an encoder model using the function. For example, the UE server 1005 may train the encoder model based on selecting or updating one or more weights associated with the encoder model using the one or more gradients. In some aspects, the one or more gradients may be obtained via an output from the encoder (e.g., Z) and an input to the encoder (e.g., Vᵢₙ). For example, the one or more gradients may be obtained based on inputting one or more activation functions and one or more input functions (e.g., ground truths) into the function. For example, the UE server 1005 may train the encoder model in a similar manner as the type 2 training, as described in more detail above. However, rather than providing the one or more activation functions and one or more input functions (e.g., ground truths) to the network server 1010 (e.g., as is the case with type 2 training), the UE server 1005 may input the one or more activations and one or more input functions (e.g., ground truths) into the function received from the network server 1010. The function may simulate the forward propagation paths (e.g., of providing the activation function into a decoder model and obtaining a Vₒᵤₜ) and the backward propagation paths (e.g., of providing a gradient based on an output of a loss function) of the trained decoder model. Therefore, the encoder model may be trained using forward propagation paths and backward propagation paths in the same training loop (e.g., in a similar manner as type 2 training) while also being trained sequentially and/or separately, unlike in type 2 training.

In some aspects, as described above, the function may include vector quantization components. For example, the function may be configured to simulate the effects of quantization on activations or other information output by, or input to, the trained decoder model. In such examples, the UE server 1005 may train a quantizer and/or a vector quantization model using the function. In other examples, the UE server 1005 (or the UE 120) may determine a codebook for vector quantization associated with compressed CSI, as described in more detail elsewhere herein (such as in connection with FIGS. 9A and 9B). For example, the UE server 1005 (and/or the UE 120) may train a vector quantization model as part of training the encoder model. For example, the UE server 1005 (and/or the UE 120) may train a quantizer associated with vector quantization. The quantization codebooks (e.g., vector codebook or scalar codebook) may be determined at the UE server 1005 (and/or the UE 120) as part of training of the encoder model. In such examples, an input provided to the function (e.g., the API) may include quantized activations (e.g., that are quantized using vector quantization and/or a quantization codebook determined by the UE server 1005 and/or the UE 120) that are output by the encoder model. In other words, the quantizer may be trained with the encoder model (e.g., and the function may not simulate the effects of such quantization).

In some aspects, as described above, the function may be associated with multiple trained decoder models. In such examples, training an encoder model may include providing, to the function, an indication of an identifier associated with a decoder model. For example, an input to the function (e.g., the API) may include a model identifier (e.g., that is associated with a given encoder model and/or decoder model). The function may be configured to provide information based on the model identifier provided to the function. In some examples, the UE server 1005 may train a single encoder model to be operational with each of the multiple trained decoder models. In other examples, the UE server 1005 may train multiple encoder models to be operational with respective decoder models from the multiple trained decoder models (e.g., if the function is associated with N trained decoder models, then the UE server 1005 may train N encoder models).

In some aspects, the UE server 1005 may receive, from another network server (e.g., another network server 1010), another function (e.g., a second function). For example, the other network server may be associated with a different network node vendor than the vendor that is associated with the network server 1010. The UE server 1005 may train the encoder using the first function (e.g., that is received from the network server 1010) and using the second function (e.g., that is received from the other network server 1010). In other words, the UE server 1005 may train the encoder model using multiple functions provided by network servers that are associated with different vendors. In this way, the trained encoder model may be configured to be operative with trained decoders that are associated with the multiple functions (e.g., in a similar manner as described in connection with FIG. 6).

As shown by reference number 1035, the UE server 1005 may transmit, and the UE 120 may receive, an indication of the trained encoder model. For example, the UE 120 may download the trained encoder model (e.g., that is trained using the function associated with the decoder model of the network node 110) from the UE server 1005. Similarly, as shown by reference number 1040, the network server 1010 may transmit, and the network node 110 may receive, an indication of the trained decoder model. For example, the network node 110 may download the trained decoder model from the network server 1010.

As shown by reference number 1045, the UE 120 and the network node 110 may communicate using the trained encoder model and the trained decoder model respectively. For example, the UE 120 may obtain CSI to be transmitted to the network node 110. The UE 120 may input the CSI into the trained encoder model. The trained encoder model may output an activation function (e.g., compressed CSI). In some aspects, the UE 120 may quantize (e.g., using a quantization codebook and/or vector quantization) the activation function output by the trained encoder model. The UE 120 may transmit, and the network node 110 may receive, the activation function (e.g., compressed CSI) that is output by the trained encoder model. In some aspects, the UE 120 may transmit, and the network node 110 may receive, a quantized representation of the activation function (e.g., compressed CSI) that is output by the trained encoder model. The network node 110 may input the activation function into the trained decoder model. The trained decoder model may output decompressed CSI that is a reconstruction of the CSI input to the encoder model (e.g., at the UE 120).

As a result, the encoder model and the decoder model may be trained using forward propagation paths and backward propagation paths in the same training loop (e.g., in a similar manner as type 2 training) while also being trained sequentially and/or separately. For example, the function provided by the first device to the second device may enable forward propagation paths and backward propagation paths (e.g., that are fixed at the first device) to be simulated at the second device for simulated joint or concurrent training. This may improve an accuracy of the training of the encoder and/or decoder models (e.g., by training concurrently and in the same loop for forward propagation and backward propagation). Additionally, this may increase a flexibility as to a timing at which training occurs (e.g., because the encoder model and the decoder model may be trained separately and/or at different times). For example, a training session may not be established between a UE server and a network server to jointly train the encoder model and the decoder model.

As indicated above, FIG. 10 is provided as an example. Other examples may differ from what is described with respect to FIG. 10.

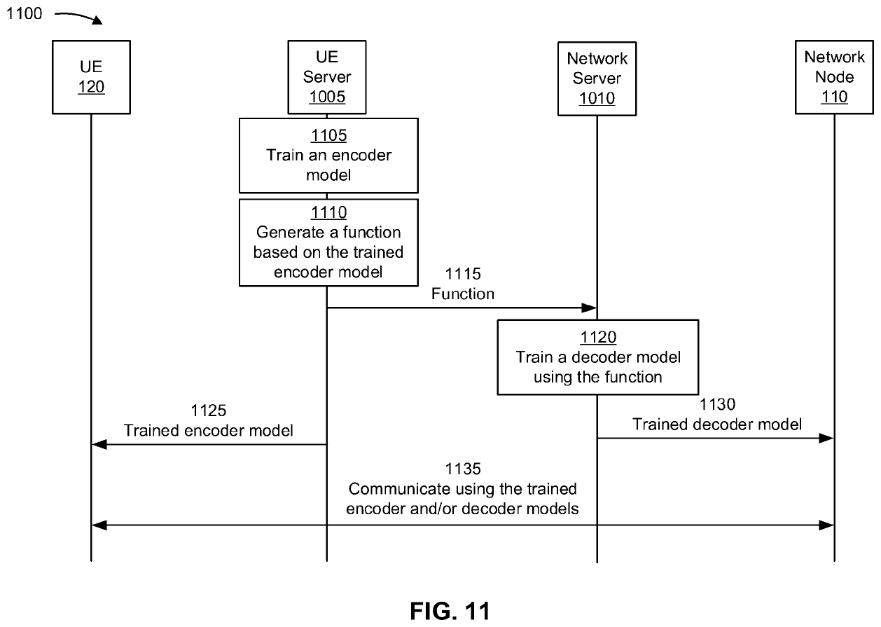

FIG. 11 is a diagram of an example 1100 associated with hybrid sequential training for encoder and decoder models, in accordance with the present disclosure. As shown in FIG. 10, the network node 110 (e.g., a base station, a CU, a DU, and/or an RU) may communicate with the UE 120. In some aspects, the network node 110 and the UE 120 may be part of a wireless network (e.g., the wireless network 100). The UE 120 and the network node 110 may have established a wireless connection prior to operations shown in FIG. 11. As shown in FIG. 11, the UE 120 may communicate with the UE server 1005 in a similar manner as described above in connection with FIG. 10. Similarly, the network node 110 may communicate with the network server 1010 in a similar manner as described above in connection with FIG. 10.

As shown by reference number 1105, the UE server 1005 may train an encoder model associated with the UE 120. For example, the UE server 1005 may train the encoder model in a similar manner as described elsewhere herein in connection with type 1 training and/or type 3 training. For example, the UE server 1005 may receive, from the UE 120, one or more data sets to be used as inputs to train the encoder model. For example, the one or more data sets may include CSI. The UE server 1005 may deploy a decoder model at the UE server 1005. The decoder model may be configured to output a reconstructed CSI (e.g., Vₒᵤₜ) based on an input of an activation function (e.g., Z). The UE server 1005 may provide a ground truth (e.g., Vᵢₙ) as an input to the encoder model. The encoder model may output an activation function (e.g., Z). The UE server 1005 may input the activation function into the decoder model. The decoder model may output a reconstruction of the ground truth (e.g., Vₒᵤₜ). The UE server 1005 may use a loss function to compare the Four to the Vᵢₙ and determine a gradient. The UE server 1005 may use the gradient to update one or more weights of the encoder model (e.g., to minimize the loss function). For example, the UE server 1005 may update one or more weights of a neural network of the encoder model using the gradient (e.g., in an attempt to minimize the loss function). The UE server 1005 may perform one or more training loops in a similar manner to update the weights of the encoder model until an output of the loss function satisfies a training threshold. For example, the UE server 1005 may perform one or more training loops until a difference between the output Vₒᵤₜ of the decoder model sufficiently reconstructs the input or ground truth Vᵢₙ that is provided to the encoder model.

As shown by reference number 1110, the UE server 1005 may generate a function based on the trained encoder model. The function may be an API, a set of instructions, code, a software program, and/or another function. The function may be configured to output an activation function (e.g., Z) based on an input of an input function (e.g., a ground truth, Vᵢₙ). For example, the function may be configured, when executed by a device (such as the network server 1010), to mimic or simulate the forward and backward propagation paths of the trained encoder model. For example, based on the training of the decoder model, the network server 1010 may configure the function to simulate the forward and backward propagation paths of the decoder model using the information obtained via the training loops and/or based on the loss function. For example, the function may be configured, when executed by a device, to accept a ground truth (e.g., Vᵢₙ) as an input and to return an activation function (e.g., Z) as an output (e.g., which may be used as an input for training a decoder model, as described in more detail elsewhere herein). In other words, the function may be configured to provide forward propagation path results (e.g., for a training loop) associated with the trained encoder model. Therefore, the decoder model may be trained using forward propagation paths and backward propagation paths in the same training loop (e.g., in a similar manner as type 2 training) while also being trained sequentially and/or separately, unlike in type 2 training.

In some aspects, the UE server 1005 may generate the function based on training the encoder model. For example, the UE server 1005 may determine activation functions that are obtained from ground truths (e.g., Vᵢₙ) during the training process of the encoder model. The UE server 1005 may configure the function to provide a given activation function based on a given ground truth input to the function (e.g., using the information obtained via the training loops and/or based on the loss function, thereby enabling a decoder model to be trained using forward propagation paths and backward propagation paths in the same training loop (e.g., in a similar manner as type 2 training) as the encoder model while also enabling the decoder model and the encoder model to be trained sequentially and/or separately). Additionally, or alternatively, the function may be pre-configured (e.g., by the vendor associated with the UE server 1005). In such examples, the UE server 1005 may obtain the function from a memory of the UE server 1005.

In some aspects, the UE server 1005 (and/or the UE 120) may determine a codebook for vector quantization associated with compressed CSI, as described in more detail elsewhere herein (such as in connection with FIGS. 9A and 9B). For example, the UE server 1005 (and/or the UE 120) may train a vector quantization model as part of training the encoder model. For example, the UE server 1005 (and/or the UE 120) may train a quantizer associated with vector quantization. The quantization codebooks (e.g., vector codebook or scalar codebook) may be determined at the UE server 1005 (and/or the UE 120) as part of training of the encoder model. In some aspects, the function (e.g., the API or other function) generated by the UE server 1005 may include vector quantization components. For example, the function may be configured to simulate the effects of quantization on activations or other information output by, or input to, the trained encoder model.

In some aspects, the UE server 1005 may generate the function to be associated with multiple encoder models. For example, the UE server 1005 may train multiple encoder models (e.g., in a similar manner as described in more detail elsewhere herein). In some aspects, the multiple encoder models may be associated with respective network node vendors. As another example, the multiple encoder models may be associated with respective types of CSI (e.g., a first encoder model may be associated with precoding vectors, a second encoder model may be associated with channel estimations, among other examples). As another example, the multiple encoder models may be associated with respective channel conditions. As another example, the multiple encoder models may be associated with respective CSI sizes (e.g., a size of CSI to be communicated between the network node 110 and the UE 120). The UE server 1005 may generate the function to be configured to simulate the forward propagation paths and the backward propagation paths of the multiple trained encoder models.

As shown by reference number 1115, the UE server 1005 may transmit, and the network server 1010 may receive, the function (e.g., that is associated with the trained encoder model). For example, the network server 1010 and the UE server 1005 may establish a connection (e.g., a wireless connection or a wired connection). The function may be transmitted to the network server 1010 from the UE server 1005 via the connection.

As shown by reference number 1120, the network server 1010 may train a decoder model using the function. For example, the network server 1010 may train the decoder model based on selecting or updating one or more weights associated with the decoder model using one or more gradients obtained from a loss function, as described in more detail elsewhere herein. The one or more gradients may be obtained based on inputting one or more input functions (e.g., ground truths) into the function. For example, the network server 1010 may train the decoder model in a similar manner as the type 2 training. However, rather than receiving the one or more activation functions and one or more input functions (e.g., ground truths) from the UE server 1005 (e.g., as is the case with type 2 training), the network server 1010 may obtain the one or more activation functions and/or one or more input functions (e.g., ground truths) from the function received from the UE server 1005. The function may simulate the forward propagation paths and the backward propagation paths of the trained encoder model. Therefore, the decoder model may be trained using forward propagation paths and backward propagation paths in the same training loop (e.g., in a similar manner as type 2 training) as the encoder model while also being trained sequentially and/or separately, unlike in type 2 training.

In some aspects, as described above, the function may include vector quantization components. For example, the function may be configured to simulate the effects of quantization on activations or other information output by, or input to, the trained decoder model. In such examples, the network server 1010 may train a quantizer and/or a vector quantization model using the function. In other examples, the network server 1010 (or the network node 110) may determine a codebook for vector quantization associated with compressed CSI, as described in more detail elsewhere herein (such as in connection with FIGS. 9A and 9B). For example, the network server 1010 (and/or the network node 110) may train a vector quantization model as part of training the encoder model. For example, the network server 1010 (and/or the network node 110) may train a quantizer associated with vector quantization. The quantization codebooks (e.g., vector codebook or scalar codebook) may be determined at the network server 1010 (and/or the network node 110) as part of the training of the decoder model. In such examples, an input provided to the function (e.g., the API) may include quantized activations (e.g., that are quantized using vector quantization and/or a quantization codebook determined by the network server 1010 and/or the network node 110) that are output by the function. In other words, the quantizer may be trained with the decoder model (e.g., and the function may not simulate the effects of such quantization).

In some aspects, as described above, the function may be associated with multiple trained encoder models. In such examples, training an encoder model may include providing, to the function, an indication of an identifier associated with a decoder model and/or an encoder model (from the multiple trained encoder models). For example, an input to the function (e.g., the API) may include a model identifier (e.g., that is associated with a given encoder model and/or decoder model). The function may be configured to provide information based on the model identifier provided to the function. In some examples, the network server 1010 may train a single decoder model to be operational with each of the multiple trained encoder models. In other examples, the network server 1010 may train multiple decoder models to be operational with respective encoder models from the multiple trained encoder models (e.g., if the function is associated with N trained encoder models, then the network server 1010 may train N decoder models).

In some aspects, the network server 1010 may receive, from another UE server (e.g., another UE server 1005), another function (e.g., a second function). For example, the other UE server may be associated with a different UE vendor than the vendor that is associated with the UE server 1005. The network server 1010 may train the decoder model using the first function (e.g., that is received from the UE server 1005) and using the second function (e.g., that is received from the other UE server). In other words, the network server 1010 may train the decoder model using multiple functions provided by UE servers that are associated with different vendors. In this way, the trained decoder model may be configured to be operative with trained encoders that are associated with the multiple functions (e.g., in a similar manner as described in connection with FIG. 6).

As shown by reference number 1125, the UE server 1005 may transmit, and the UE 120 may receive, an indication of the trained encoder model. For example, the UE 120 may download the trained encoder model from the UE server 1005. Similarly, as shown by reference number 1130, the network server 1010 may transmit, and the network node 110 may receive, an indication of the trained decoder model (e.g., that is trained using the function associated with the encoder model of the UE 120). For example, the network node 110 may download the trained decoder model from the network server 1010.

As shown by reference number 1135, the UE 120 and the network node 110 may communicate using the trained encoder model and the trained decoder model respectively. For example, the UE 120 may obtain CSI to be transmitted to the network node 110. The UE 120 may input the CSI into the trained encoder model. The trained encoder model may output an activation function (e.g., compressed CSI). In some aspects, the UE 120 may quantize (e.g., using a quantization codebook and/or vector quantization) the activation function output by the trained encoder model. The UE 120 may transmit, and the network node 110 may receive, the activation function (e.g., compressed CSI) that is output by the trained encoder model. In some aspects, the UE 120 may transmit, and the network node 110 may receive, a quantized representation of the activation function (e.g., compressed CSI) that is output by the trained encoder model. The network node 110 may input the activation function into the trained decoder model. The trained decoder model may output decompressed CSI that is a reconstruction of the CSI input to the encoder model (e.g., at the UE 120).

As a result, the encoder model and the decoder model may be trained using forward propagation paths and backward propagation paths in the same training loop (e.g., in a similar manner as type 2 training) while also being trained sequentially and/or separately. For example, the function provided by the first device to the second device may enable forward propagation paths and backward propagation paths (e.g., that are fixed at the first device) to be simulated at the second device for simulated joint or concurrent training. This may improve an accuracy of the training of the encoder and/or decoder models (e.g., by training concurrently and in the same loop for forward propagation and backward propagation). Additionally, this may increase a flexibility as to a timing at which training occurs (e.g., because the encoder model and the decoder model may be trained separately and/or at different times). For example, a training session may not be established between a UE server and a network server to jointly train the encoder model and the decoder model.

As indicated above, FIG. 11 is provided as an example. Other examples may differ from what is described with respect to FIG. 11.

FIG. 12 is a diagram illustrating an example process 1200 performed, for example, by a first device, in accordance with the present disclosure. Example process 1200 is an example where the first device (e.g., a server, the UE server 1005, the network server 1010, a UE 120, and/or a network node 110) performs operations associated with hybrid sequential training for encoder and decoder models.

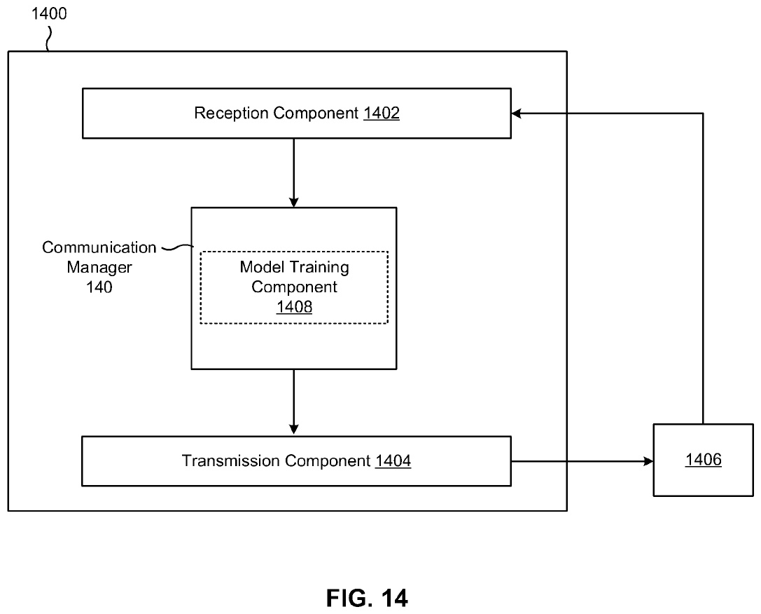

As shown in FIG. 12, in some aspects, process 1200 may include receiving, from a second device, a function associated with a trained first model, the function being configured to output one or more gradients associated with the trained first model (block 1210). For example, the first device (e.g., using communication manager 140 and/or reception component 1402, depicted in FIG. 14) may receive, from a second device, a function associated with a trained first model, the function being configured to output one or more gradients associated with the trained first model, as described above.

As further shown in FIG. 12, in some aspects, process 1200 may include training a second model based on selecting one or more weights associated with the second model using the one or more gradients, the one or more gradients being obtained based on inputting one or more activations and one or more inputs into the function (block 1220). For example, the first device (e.g., using communication manager 140 and/or model training component 1408, depicted in FIG. 14) may train a second model based on selecting one or more weights associated with the second model using the onc or more gradients, the one or more gradients being obtained based on inputting one or more activations and one or more inputs into the function, as described above.

Process 1200 may include additional aspects, such as any single aspect or any combination of aspects described below and/or in connection with one or more other processes described elsewhere herein.

In a first aspect, process 1200 includes transmitting, to a UE or a network node, the second model after training the second model.

In a second aspect, alone or in combination with the first aspect, the second model is configured to output compressed CSI, the one or more activations including the compressed CSI, and the trained first model is configured to output CSI from an input of the compressed CSI, the one or more inputs including the CSI.

In a third aspect, alone or in combination with one or more of the first and second aspects, process 1200 includes training a vector quantization model using the one or more gradients.

In a fourth aspect, alone or in combination with one or more of the first through third aspects, the function is configured to perform vector quantization associated with an output of the function.

In a fifth aspect, alone or in combination with one or more of the first through fourth aspects, the function is associated with multiple trained first models, and training the second model comprises providing an identifier associated with the trained first model as an input to the function.

In a sixth aspect, alone or in combination with one or more of the first through fifth aspects, training the second model further comprises training the second model to be configured to operate with each of the multiple trained first models.

In a seventh aspect, alone or in combination with one or more of the first through sixth aspects, training the second model further comprises training multiple second models, including the second model, to be configured to operate with respective trained first models from the multiple trained first models.

In an eighth aspect, alone or in combination with one or more of the first through seventh aspects, the function is a first function, process 1200 includes receiving, from a third device, an indication of a second function associated with another trained first model, and training the second model comprises training the second model using the first function and the second function.

In a ninth aspect, alone or in combination with one or more of the first through eighth aspects, the function is an API.

In a tenth aspect, alone or in combination with one or more of the first through ninth aspects, the first device is a server associated with a UE, the trained first model is a decoder model, and the second model is an encoder model (e.g., in a similar manner as depicted and described in connection with FIG. 10). In some aspects, the function may be configured to use an activation function (e.g., Z) and a ground truth (e.g., Vᵢₙ) as an input and the function may output the one or more gradients (e.g., to simulate a forward and backward propagation path of the decoder model). The one or more gradients may be used to update the one or more weights of the encoder model.

In an eleventh aspect, alone or in combination with one or more of the first through tenth aspects, the first device is a server associated with a network node, the trained first model is an encoder model, and the second model is a decoder model (e.g., in a similar manner as depicted and described in connection with FIG. 11). In some aspects, the function may use a ground truth (e.g., Vᵢₙ) as an input and the function may output an activation function (e.g., Z). The output of the function (e.g., the activation function, Z) may be used as an input to the decoder model to train the decoder model.

In a twelfth aspect, alone or in combination with one or more of the first through eleventh aspects, the first device is a UE or a network node.

In a thirteenth aspect, alone or in combination with one or more of the first through twelfth aspects, the function is configured to simulate a forward propagation path and a backward propagation path of the trained first model based on the one or more gradients.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a first device, in accordance with the present disclosure. Example process 1300 is an example where the first device (e.g., a server, the UE server 1005, the network server 1010, a UE 120, and/or a network node 110) performs operations associated with hybrid sequential training for encoder and decoder models.

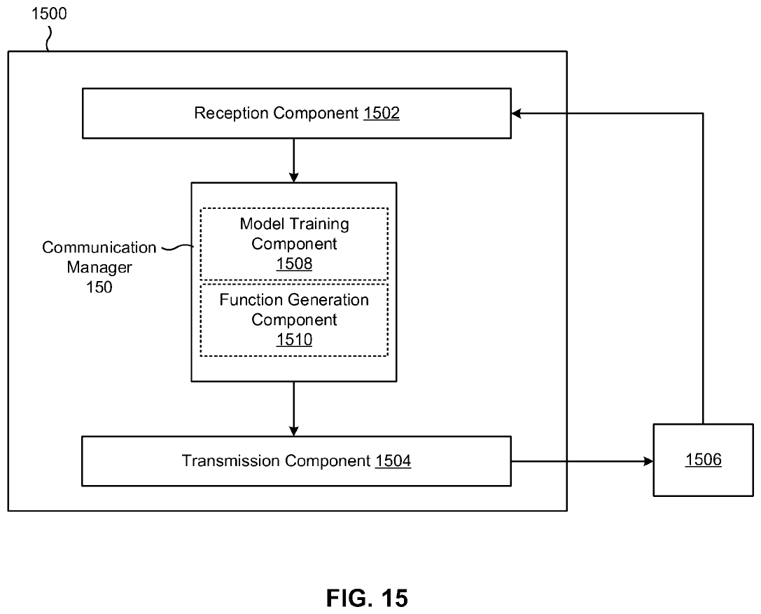

As shown in FIG. 13, in some aspects, process 1300 may include training a first model based on one or more inputs to obtain a trained first model, the trained first model being associated with one or more activations associated with an output of the trained first model (block 1310). For example, the first device (e.g., using communication manager 150 and/or model training component 1508, depicted in FIG. 15) may train a first model based on one or more inputs to obtain a trained first model, the trained first model being associated with one or more activations associated with an output of the trained first model, as described above.

As further shown in FIG. 13, in some aspects, process 1300 may include transmitting, to a second device, a function associated with the trained first model, the function being configured to output one or more activations based on a ground truth input (block 1320). For example, the first device (e.g., using communication manager 150 and/or transmission component 1504, depicted in FIG. 15) may transmit, to a second device, a function associated with the trained first model, the function being configured to output one or more activations based on a ground truth input, as described above.

Process 1300 may include additional aspects, such as any single aspect or any combination of aspects described below and/or in connection with one or more other processes described elsewhere herein.

In a first aspect, process 1300 includes transmitting, to a UE or a network node, the trained first model after training the first model.

In a second aspect, alone or in combination with the first aspect, the trained first model is configured to output compressed CSI or to output CSI from an input of the compressed CSI.

In a third aspect, alone or in combination with one or more of the first and second aspects, process 1300 includes training a vector quantization model using the trained first model.

In a fourth aspect, alone or in combination with one or more of the first through third aspects, the function is configured to perform vector quantization associated with an output of the function.

In a fifth aspect, alone or in combination with one or more of the first through fourth aspects, the function is an API.

In a sixth aspect, alone or in combination with one or more of the first through fifth aspects, the first device is a server associated with a network node, the first model is a decoder model, and the second device is associated with a UE and an encoder model (e.g., in a similar manner as depicted and described in connection with FIG. 10). In some aspects, the function may be configured to use an activation function (e.g., Z) and a ground truth (e.g., Vᵢₙ) as an input and the function may output the one or more gradients (e.g., to simulate a forward and backward propagation path of the decoder model). The one or more gradients may be used to update the one or more weights of the encoder model

In a seventh aspect, alone or in combination with one or more of the first through sixth aspects, the first device is a server associated with a UE, the first model is an encoder model, and the second device is associated with a network node and a decoder model (e.g., in a similar manner as depicted and described in connection with FIG. 11). In some aspects, the function may use a ground truth (e.g., Vᵢₙ) as an input and the function may output an activation function (e.g., Z). The output of the function (e.g., the activation function, Z) may be used as an input to the decoder model to train the decoder model.

In an eighth aspect, alone or in combination with one or more of the first through seventh aspects, the first device is a network node or a UE.

In a ninth aspect, alone or in combination with one or more of the first through eighth aspects, the function is configured to simulate a forward propagation path and a backward propagation path of the first model.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a first device, or a first device may include the apparatus 1400. In some aspects, the first device may be a server, the UE server 1005, the network server 1010, a UE 120, and/or a network node 110. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 140. The communication manager 140 may include a model training component 1408, among other examples.

In some aspects, the apparatus 1400 may be configured to perform one or more operations described herein in connection with FIGS. 10 and 11. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the first device described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, a modem, a demodulator, a MIMO detector, a receive processor, a controller/processor, a memory, or a combination thereof, of the first device described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the gencrated communications to the transmission component 1404 for transmission to the apparatus 1406. In some aspects, the transmission component 1404 may perform signal processing on the generated communications (such as filtering, amplification, modulation, digital-to- analog conversion, multiplexing, interleaving, mapping, or encoding, among other examples), and may transmit the processed signals to the apparatus 1406. In some aspects, the transmission component 1404 may include one or more antennas, a modem, a modulator, a transmit MIMO processor, a transmit processor, a controller/processor, a memory, or a combination thereof, of the first device described in connection with FIG. 2. In some aspects, the transmission component 1404 may be co-located with the reception component 1402 in a transceiver.

The reception component 1402 may receive, from a second device, a function associated with a trained first model, the function being configured to output one or more gradients based on an input of an activation and an input. The model training component 1408 may train a second model based on selecting one or more weights associated with the second model using the one or more gradients, the one or more gradients being obtained based on inputting one or more activations and one or more inputs into the function.

The transmission component 1404 may transmit, to a UE or a network node, the second model after training the second model.

The model training component 1408 may train a vector quantization model using the one or more gradients.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a first device, or a first device may include the apparatus 1500. In some aspects, the first device may be a server, the UE server 1005, the network server 1010, a UE 120, and/or a network node 110. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150. The communication manager 150 may include one or more of a model training component 1508, and/or a function generation component 1510, among other examples.

In some aspects, the apparatus 1500 may be configured to perform one or more operations described herein in connection with FIGS. 10 and 11. Additionally, or alternatively, the apparatus 1500 may be configured to perform one or more processes described herein, such as process 1300 of FIG. 13, or a combination thereof. In some aspects, the apparatus 1500 and/or one or more components shown in FIG. 15 may include one or more components of the first device described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, a modem, a demodulator, a MIMO detector, a receive processor, a controller/processor, a memory, or a combination thereof, of the first device described in connection with FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the gencrated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modem, a modulator, a transmit MIMO processor, a transmit processor, a controller/processor, a memory, or a combination thereof, of the first device described in connection with FIG. 2. In some aspects, the transmission component 1504 may be co-located with the reception component 1502 in a transceiver.

The model training component 1508 may train a first model based on one or more inputs to obtain a trained first model, the trained first model being associated with one or more activations associated with an output of the trained first model. The transmission component 1504 may transmit, to a second device, a function associated with the trained first model, the function being configured to output one or more activations based on a ground truth input.

The transmission component 1504 may transmit, to a UE or a network node, the trained first model after training the first model.

The model training component 1508 may train a vector quantization model using the trained first model.

The function generation component 1510 may generate the function based at least in part on training the first model.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:
Aspect 1: A method of wireless communication performed by a first device, comprising: receiving, from a second device, a function associated with a trained first model, the function being configured to output one or more gradients associated with the trained first model; and training a second model based on selecting one or more weights associated with the second model using the one or more gradients, the one or more gradients being obtained based on inputting one or more activations and one or more inputs into the function. This enables the trained first model and the second model to be trained using forward propagation paths and backward propagation paths in the same training loop (e.g., in a similar manner as type 2 training) while also being trained sequentially and/or separately.
Aspect 2: The method of Aspect 1, further comprising: transmitting, to a user equipment (UE) or a network node, the second model after training the second model.

This increases a flexibility as to a timing at which training occurs.
Aspect 3: The method of any of Aspects 1-2, wherein the second model is configured to output compressed channel state information (CSI), the one or more activations including the compressed CSI, and wherein the trained first model is configured to output CSI from an input of the compressed CSI, the one or more inputs including the CSI. This improves an accuracy of the CSI compression models (e.g., by training the models concurrently and in the same loop for forward propagation and backward propagation).
Aspect 4: The method of any of Aspects 1-3, further comprising: training a vector quantization model using the one or more gradients.
Aspect 5: The method of any of Aspects 1-3, wherein the function is configured to perform vector quantization associated with an output of the function.
Aspect 6: The method of any of Aspects 1-5, wherein the function is associated with multiple trained first models, and wherein training the second model comprises: providing an identifier associated with the trained first model as an input to the function. This enables a single function to simulate forward and backward propagation paths for multiple trained models, thereby conserving resources that would have otherwise been used to configure, transmit, and/or use multiple functions for the multiple trained models.
Aspect 7: The method of Aspect 6, wherein training the second model further comprises: training the second model to be configured to operate with each of the multiple trained first models. This enables the second model to be trained to operate with the multiple trained models, hereby conserving resources that would have otherwise been used to configure, transmit, and/or use multiple models for the multiple trained models.
Aspect 8: The method of Aspect 6, wherein training the second model further comprises: training multiple second models, including the second model, to be configured to operate with respective trained first models from the multiple trained first models.
Aspect 9: The method of any of Aspects 1-8, wherein the function is a first function, the method further comprising: receiving, from a third device, an indication of a second function associated with another trained first model, and wherein training the second model comprises: training the second model using the first function and the second function.
Aspect 10: The method of any of Aspects 1-9, wherein the function is an application programming interface (API).
Aspect 11: The method of any of Aspects 1-10, wherein the first device is a server associated with a user equipment (UE), wherein the trained first model is a decoder model, and wherein the second model is an encoder model.
Aspect 12: The method of any of Aspects 1-10, wherein the first device is a server associated with a network node, wherein the trained first model is an encoder model, and wherein the second model is a decoder model.
Aspect 13: The method of any of Aspects 1-10, wherein the first device is a user equipment (UE) or a network node.
Aspect 14: A method of wireless communication performed by a first device, comprising: training a first model based on one or more inputs to obtain a trained first model, the trained first model being associated with one or more activations associated with an output of the trained first model; and transmitting, to a second device, a function associated with the trained first model, the function being configured to output one or more activations based on a ground truth input.
Aspect 15: The method of Aspect 14, further comprising: transmitting, to a user equipment (UE) or a network node, the trained first model after training the first model.
Aspect 16: The method of any of Aspects 14-15, wherein the trained first model is configured to output compressed channel state information (CSI) or to output CSI from an input of the compressed CSI.
Aspect 17: The method of any of Aspects 14-16, further comprising: training a vector quantization model using the trained first model.
Aspect 18: The method of any of Aspects 14-16, wherein the function is configured to perform vector quantization associated with an output of the function.
Aspect 19: The method of any of Aspects 14-18, wherein the function is an application programming interface (API).
Aspect 20: The method of any of Aspects 14-19, wherein the first device is a server associated with a network node, wherein the first model is a decoder model, and wherein the second device is associated with a user equipment (UE) and an encoder model.
Aspect 21: The method of any of Aspects 14-19, wherein the first device is a server associated with a user equipment (UE), wherein the first model is an encoder model, and wherein the second device is associated with a network node and a decoder model.
Aspect 22: The method of any of Aspects 14-19, wherein the first device is a network node or a user equipment (UE).
Aspect 23: An apparatus for wireless communication at a device, comprising one or more processors; one or more memories coupled with the one or more processors; and instructions stored in the one or more memories and executable by the one or more processors to cause the apparatus to perform the method of one or more of Aspects 1-13.
Aspect 24: A device for wireless communication, comprising one or more memories and one or more processors coupled to the one or more memories, the one or more processors configured to perform the method of one or more of Aspects 1-13.
Aspect 25: An apparatus for wireless communication, comprising at least one means for performing the method of one or more of Aspects 1-13.
Aspect 26: A non-transitory computer-readable medium storing code for wireless communication, the code comprising instructions executable by one or more processors to perform the method of one or more of Aspects 1-13.
Aspect 27: A non-transitory computer-readable medium storing a set of instructions for wireless communication, the set of instructions comprising one or more instructions that, when executed by one or more processors of a device, cause the device to perform the method of one or more of Aspects 1-13.
Aspect 28: An apparatus for wireless communication at a device, comprising one or more processors; one or more memories coupled with the one or more processors; and instructions stored in the one or more memories and executable by the one or more processors to cause the apparatus to perform the method of one or more of Aspects 14-22.
Aspect 29: A device for wireless communication, comprising one or more memories and one or more processors coupled to the one or more memories, the one or more processors configured to perform the method of one or more of Aspects 14-22.
Aspect 30: An apparatus for wireless communication, comprising at least one means for performing the method of one or more of Aspects 14-22.
Aspect 31: A non-transitory computer-readable medium storing code for wireless communication, the code comprising instructions executable by one or more processors to perform the method of one or more of Aspects 14-22.
Aspect 32: A non-transitory computer-readable medium storing a set of instructions for wireless communication, the set of instructions comprising one or more instructions that, when executed by one or more processors of a device, cause the device to perform the method of one or more of Aspects 14-22.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A first device for wireless communication, comprising:
one or more memories; and
one or more processors, coupled to the one or more memories, configured to:
receive, from a second device, a function associated with a trained first model, the function being configured to output one or more gradients associated with the trained first model; and
train a second model based on selecting one or more weights associated with the second model using the one or more gradients, the one or more gradients being obtained based on inputting one or more activations and one or more inputs into the function.

2. The first device of claim 1, wherein the one or more processors are further configured to:
transmit, to a user equipment (UE) or a network node, the second model after training the second model.

3. The first device of claim 1, wherein the second model is configured to output compressed channel state information (CSI), the one or more activations including the compressed CSI, and
wherein the trained first model is configured to output CSI from an input of the compressed CSI, the one or more inputs including the CSI.

4. The first device of claim 1, wherein the one or more processors are further configured to:
train a vector quantization model using the one or more gradients.

5. The first device of claim 1, wherein the function is configured to perform vector quantization associated with an output of the function.

6. The first device of claim 1, wherein the function is associated with multiple trained first models, and wherein the one or more processors, to train the second model, are configured to:
provide an identifier associated with the trained first model as an input to the function.

7. The first device of claim 6, wherein the one or more processors, to train the second model, are configured to:
train the second model to be configured to operate with each of the multiple trained first models.

8. The first device of claim 6, wherein the one or more processors, to train the second model, are configured to:
train multiple second models, including the second model, to be configured to operate with respective trained first models from the multiple trained first models.

9. The first device of claim 1, wherein the function is a first function, wherein the one or more processors are further configured to:
receive, from a third device, an indication of a second function associated with another trained first model, and
wherein the one or more processors, to train the second model, are configured to:
train the second model using the first function and the second function.

10. The first device of claim 1, wherein the function is an application programming interface (API).

11. The first device of claim 1, wherein the first device is a server associated with a user equipment (UE), wherein the trained first model is a decoder model, and wherein the second model is an encoder model.

12. The first device of claim 1, wherein the first device is a user equipment (UE) or a network node.

13. The first device of claim 1, wherein the function is configured to simulate a forward propagation path and a backward propagation path of the trained first model based on the one or more gradients.

14. A first device for wireless communication, comprising:
one or more memories; and
one or more processors, coupled to the one or more memories, configured to:
train a first model based on one or more inputs to obtain a trained first model, an output of the trained first model being associated with one or more activations; and
transmit, to a second device, a function associated with the trained first model, the function being configured to output one or more activations based on a ground truth input.

15. The first device of claim 14, wherein the one or more processors are further configured to:
transmit, to a user equipment (UE) or a network node, the trained first model after training the first model.

16. The first device of claim 14, wherein the trained first model is configured to output compressed channel state information (CSI) or to output CSI from an input of the compressed CSI.

17. The first device of claim 14, wherein the one or more processors are further configured to:
train a vector quantization model using the trained first model.

18. The first device of claim 14, wherein the function is configured to perform vector quantization associated with an output of the function.

19. The first device of claim 14, wherein the first device is a first server associated with a network node, wherein the first model is a decoder model, and wherein the second device is a second server associated with a user equipment (UE).

20. A method of wireless communication performed by a first device, comprising:
receiving, from a second device, a function associated with a trained first model, the function being configured to output one or more gradients associated with the trained first model; and
training a second model based on selecting one or more weights associated with the second model using the one or more gradients, the one or more gradients being obtained based on inputting one or more activations and one or more inputs into the function.

21-30. (canceled)
